(19) United States
(12) Patent Application Publication
(10) Pub. No.: US 2015/0217442 A1
(43) Pub. Date: Aug. 6, 2015

(54) INSTALLATION DEVICE FOR STORM DRAIN TRAP

(71) Applicant: James Russell ALEXANDER, Surrey (CA)

(72) Inventor: James Russell ALEXANDER, Surrey (CA)

(21) Appl. No.: 14/170,223

(22) Filed: Jan. 31, 2014

(51) Int. Cl. B25J 1/04; E03F 1/00

(52) U.S. Cl. CPC B25J 1/04; E03F 1/00

(57) ABSTRACT

Provided herein is a device for installation, maintenance, or removal of a catch basin trap; the device comprising a shank connecting a handle on one end and jaw-like arms on an opposite end, wherein the handle end of the shank further comprises a lever capable of actuating the jaw-like arms for snap-action installation of a catch basin trap. Also, provided herein are methods and kits comprising the trap installation device.

### FIELD OF THE INVENTION

The present invention relates to the field of devices and methods for installing and/or maintaining and/or uninstalling traps, filters, inserts, bags, and the like for catch basins in storm water drains.

### BACKGROUND OF THE DISCLOSURE

It is well known that storm water run-off is one of the major sources of water pollution. Therefore, it is a common, and often well regulated, practice in many municipalities to use and/or retrofit a catch basin of a storm drain with a trap, pipe, filter, insert, or bag for the collection of debris, so that debris is precluded from washing out to and contaminating the sea or some other body of water. Such traps need to be installed, maintained, and/or uninstalled by maintenance workers or other individuals on a routine basis. When doing such maintenance work, a worker needs to place himself/herself in an unsafe position (e.g., a prone position on a street), rely on multiple tools such as high-powered hammer drills, screwdrivers and wrenches, and invest excessive amounts of time to complete the work properly.

Catch basins, hooded catch basins and/or traps designed for the same are readily available and may be found, for example, in U.S. Pat. Nos. 2,196,116; 2,256,045; 2,703,251; 8,512,556; and 5,004,534; US Publication Nos. 20080035570; 20110315617; and 20130008851; and CA Publication Nos. 1261559; however, none of these references disclose the embodiments of the present invention.

Therefore, a need exists in the art for a device and/or kit and/or method for safer, more efficient installation, maintenance, and/or removal of traps for catch basins in storm drains.

All documents and references cited herein and in the referenced patent documents, are hereby incorporated herein by reference.

### SUMMARY OF THE INVENTION

The present inventors have designed, constructed, and developed an innovative device for a simple, efficient swivel snap-action installation, maintenance, and/or removal of traps for storm drain catch basins. Such a device is capable of clasping or gripping or grappling a trap for a catch basin in actuating, spring-loaded jaw-like arms. The device is also capable of swiveling and/or rotating and/or positioning the trap at an angle sufficient for insertion into a catch basin. This unique lever-activated device facilitates a snap-action installation of a trap allowing the individual to remain upright thereby alleviating the need for the individual to lie on the ground in an unsafe prone position to install and/or remove a trap in/from a corresponding catch basin of a storm drain.

Disclosed herein is a device for installation, maintenance, or removal of a catch basin trap; the device comprising a shank connecting a handle on one end and jaw-like arms on an opposite end, wherein the handle end of the shank further comprises a lever capable of actuating the jaw-like arms for snap action installation of a catch basin trap.

In another embodiment, the jaw-like arms of the device are capable of swiveling at an angle sufficient for installing the trap in or removing the trap from a corresponding catch basin. In a further embodiment, the swivel of the jaw-like arms of the device rotates the arms up to a 228° angle.

In another embodiment, the shank of the device is a hollow shank.

In another embodiment, the handle end of the device comprises a hand grip.

In another embodiment, the lever of the device is connected to a pin via a cable, wherein the lever is capable of activating release of the pin for the snap-action installation.

Additionally, disclosed herein is a method for installing, maintaining, or removing a catch basin trap; the method comprising; providing a device comprising a shank connecting a handle on one end and jaw-like arms on an opposite end, wherein the handle end of the shank further comprises a lever capable of actuating the jaw-like arms for snap action installation of a catch basin trap; and activating the lever of the device to actuate the jaw-like arms; thereby snapping into place a trap in a corresponding catch basin.

In another embodiment, the method further comprises positioning the jaw-like arms at a desired angle for the snap-action installation of the trap into the corresponding catch basin.

In another embodiment of the method, the swivel of the jaw-like arms of the device rotates the arms up to a 228° angle.

In another embodiment of the method, the shank of the device is a hollow shank.

In another embodiment, the handle end of the device comprises a hand grip.

Also disclosed herein is a kit for installing a catch basin trap; the kit comprising: a device comprising a shank connecting a handle on one end and jaw-like arms on an opposite end, wherein the handle end of the shank further comprises a lever capable of actuating the jaw-like arms for snap action installation of a catch basin trap; and; a catch basin trap.

In other embodiments, the trap installation device, and methods and kits utilizing the device disclosed herein in the preceding paragraphs may additionally incorporate any of the preceding or subsequent disclosed embodiments.

The Summary of the Invention is not intended to define the claims nor is it intended to limit the scope of the invention in any manner.

Other features and advantages of the invention will be apparent from the following Drawings, Detailed Description, and the Claims.

### BRIEF DESCRIPTION OF THE DRAWINGS

FIG. 1 illustrates a perspective view of an embodiment of the device with the jaw-like arms of the device clasping a catch basin trap.

FIG. 2 illustrates an alternative perspective view of an embodiment of the device with the jaw-like arms of the device clasping a catch basin trap.

FIG. 3 illustrates an alternative perspective view of an embodiment of the device with jaw-like arms of the device, swiveled and positioned at a particular angle, clasping a catch basin trap.

FIG. 4 illustrates an alternative perspective view of an embodiment of the device swiveling, at a particular angle, the jaw-like arms of the device clasping a catch basin trap.

FIG. 5A illustrates a perspective view of an embodiment of the device disclosed herein comprising a tightening handle at the connection point of the shank and the jaw-like arms of the device.

FIG. 5B illustrates an alternative perspective view of an embodiment of the device disclosed herein comprising a tightening handle at the bottom portion of the shank so that the tightening handle is capable of controlling the swivel function of the actuating jaws and so that the jaw-like arms may be positioned and locked in a desired angle for installation of the trap.

FIG. 6 illustrates an alternative perspective view of an embodiment of the device at the connection point of the shank and the jaw-like arms of the device.

FIG. 7A illustrates a perspective view of an embodiment of the device disclosed herein, positioned in a particular angle of rotation, and gripping a hood of a catch basin trap.

FIG. 7B illustrates an alternative perspective view of an embodiment of the device disclosed herein positioned in a particular angle of rotation, and gripping a hood of a catch basin trap.

FIG. 7C illustrates an alternative perspective view of an embodiment of the device disclosed herein positioned in a particular angle of rotation, and gripping a hood of a catch basin trap so that the device is used to drop and/or slide the hood over an installed trap.

### DETAILED DESCRIPTION OF THE EMBODIMENTS

The present invention is illustrated in the drawings and description in which like elements are assigned the same reference numerals. However, while particular embodiments are illustrated in the drawings, there is no intention to limit the present invention to the specific embodiment or embodiments disclosed. Rather, the present invention is intended to cover all modifications, alternative constructions, and equivalents falling within the spirit and scope of the invention. As such, the drawings are intended to be illustrative and not restrictive.

Unless otherwise defined, all technical terms used herein have the same meaning as commonly understood by one of ordinary skill in the art to which this technology belongs.

A catch basin is readily known in the art as functioning to collect storm water, or waste water, and re-directing the surface water excess from causing flooding. Catch basins typically, in combination with a network of pipes and additional catch basins, flow to an outlet point such as an ocean, lake, stream, river or sparsely populated areas. However, catch basins are also often the entry point of pollutants and/or debris from sources found in surface water excess and/or storm water run-off. Such pollutants and/or debris include, without limitation, hydrocarbons (i.e., oil), bacteria, sediment, trash, plastics, metals, sand, silt, organic material such as leaves, and grass clippings, particulates, soil, pharmaceutical waste, detergents, coolants, grease, fertilizer, pesticides, paint, and feces. As a result, polluted storm water may be discharged, untreated, directly into bodies of water such as oceans, bays, rivers, lakes, and streams.

Catch basin traps are well known as often being employed for alleviating pollutants and/or debris from contaminating the water source at the outlet point. For the purposes of the present invention, a “trap” for a catch basin of a storm drain is a term which may be used interchangeably with the terms “system”, “trap system”, “insert”, “pipe”, “hood”, “hood assembly”, “bag”, and/or “filter”. Generally, a trap is designed to collect and/or catch and/or filter debris and larger particles from flowing into a body of water; thereby contaminating the body of water.

For the purposes of the present invention, the terminology “corresponds to” means that there is a spatial and/or functional relationship between two or more objects, components and/or parts which correspond to each other. For example, a catch basin trap or pipe corresponds to and/or functions with and/or fits with (into or out of) a corresponding catch basin of a storm drain.

For the purposes of the present invention, certain terms used herein may also be found in other fields as apparent to a person skilled in the art. For this reason, such terms used herein should not be taken as to limit the scope of the present invention and includes all other types of objects or related fields with which the present invention may be used and may be useful.

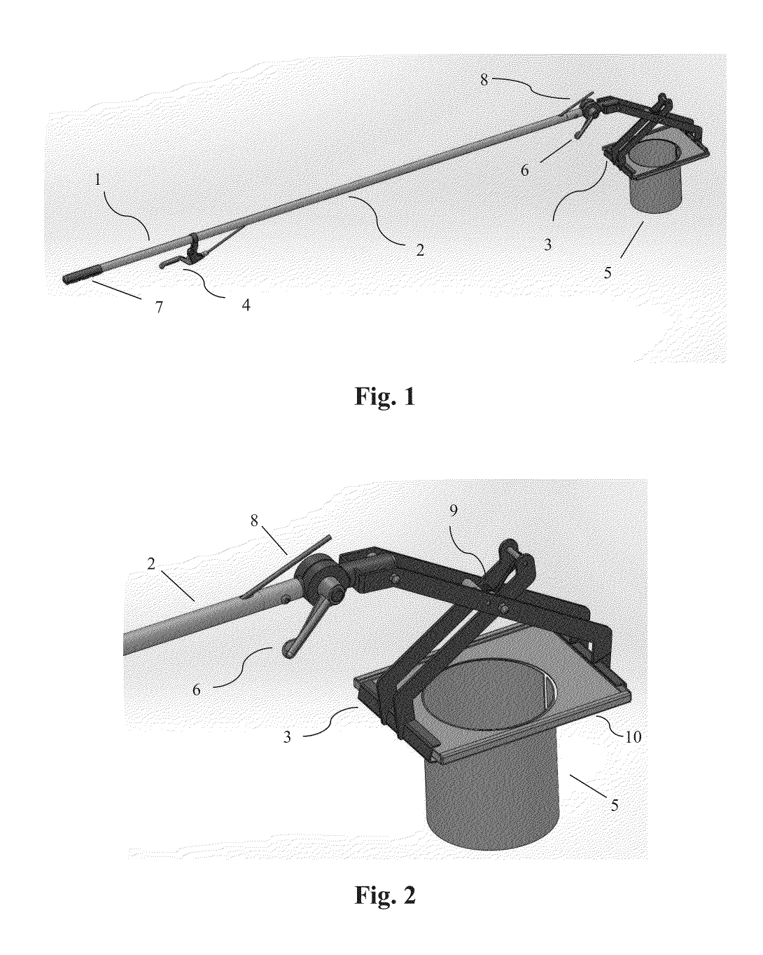

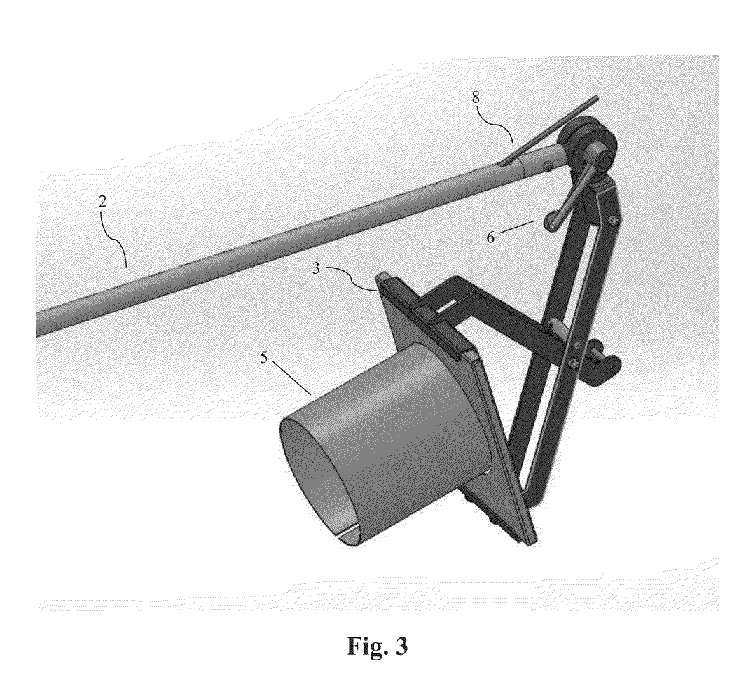

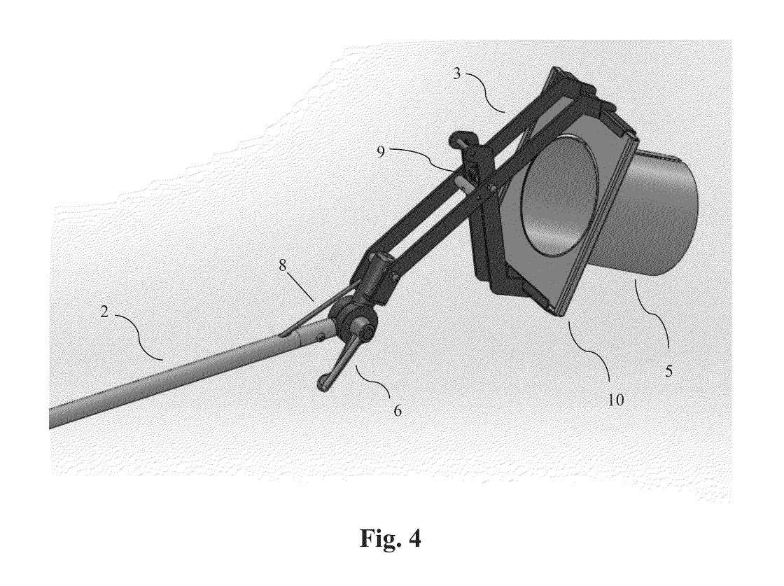

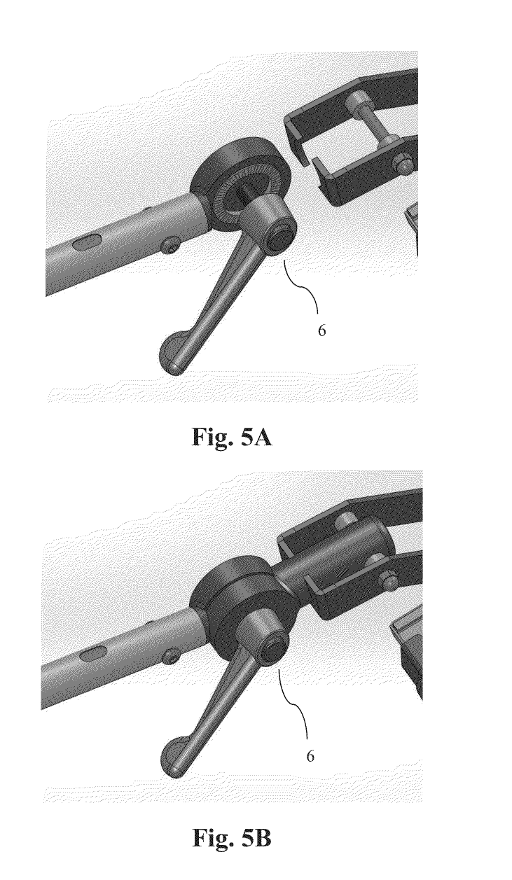

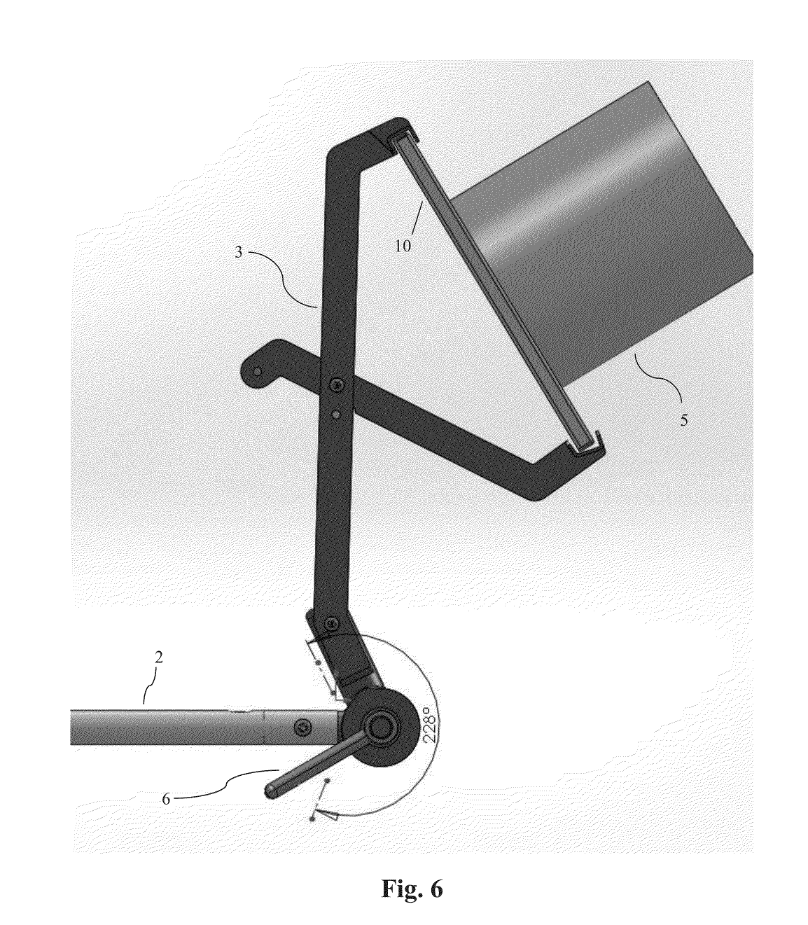

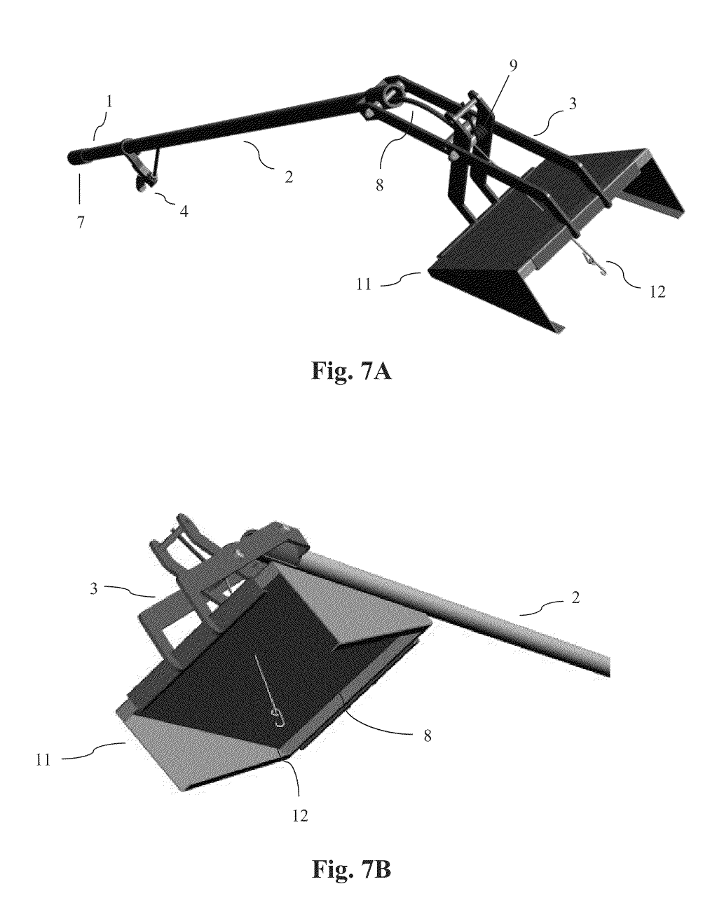

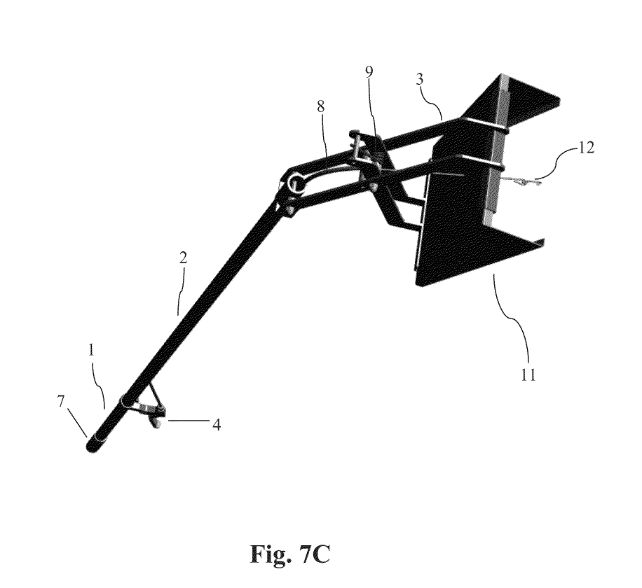

Exemplary embodiments of the present invention are depicted in FIGS. 1-7.

FIGS. 1-7 show embodiments of an actuating storm drain trap installation device. Exemplary positions of the device are shown, without limitation.

In one embodiment, the actuating jaws 3 of the device disclosed herein are positioned over the face 10 (often square-shaped or rectangular) of a trap 5 to be installed in a catch basin. A hand lever 4 located on the upper portion (handle end 1) of the shank 2 of the device functions by pulling a pin situated in the trap 5 triggering the trap 5 to expand and/or lock into, through a spring-loaded 9 snap-action, a catch basin of a storm drain and/or a preexisting pipe/trap of the catch basin. The installer (individual using the device) uses an adjoined clasp or pin catch on the device to latch onto and/or make a connection to the pin on the trap 5. In one embodiment the clasp is adjoined to the device via a cable 8. The installer presses the lever 4 down with minimal force to release the jaws 3 of the device from the expandable and/or expanded pipe of the trap 5 thereby releasing the pin from its connection to the catch basin trap 5. When the installer presses and/or squeezes the hand lever 4 (located at the top portion of the device disclosed herein) this causes the lever 4—which lever 4 is connected to a cable 8, which cable 8 is in turn connected to a clasp, which clasp is in turn hooked to/connected to the pin—to release and/or pull out the pin so that the trap 5 springs open and/or snaps into place via a snap-action and/or is held into place in the catch basin of a storm drain. In certain embodiments, the handle end 1 of the shank 2 of the device disclosed herein comprises a hand grip 7.

In certain embodiments, the installer adjusts the swivel or rotation of the device disclosed herein at the bottom portion of the shank 2 so that the jaws 3 are positioned at a sufficient angle for installation of the trap 5 into the catch basin. This function can be achieved manually such as by manual adjustment of the actuating jaws 3 of the device so the jaws 3 are locked into position at the desired angle. In one embodiment, the actuating jaws 3 may be adjusted via a tightening handle 6 which controls the swivel function of the actuating jaws 3 so that they may be positioned and locked in the desired angle for installation of the trap 5. In a further embodiment, the tightening handle 6 is located at the bottom portion of the shank 2. In another embodiment of the device disclosed herein, a knuckle or pivot is located at the mid portion of the shank 2 to provide for an additional and/or alternative means for adjustment of the angle of the actuating jaws 3 for installation of a catch basin trap 5.

In another embodiment, the installer will position the jaws 3 of the device disclosed herein over a corresponding hood of the trap 5 and the device is then used to drop and/or slide the hood over the installed trap 5.

The device disclosed herein is made from material readily known and available. In general, the device disclosed herein may be comprised of material, without limitation, selected from the group consisting of carbon steel, aluminum, stainless steel, carbon composite, and a combination thereof.

The trap installation device disclosed herein may incorporate any number of design features, dimensions, and/or variations known and/or readily available to the skilled artisan. For example, the trap installation device of the present invention may include, without limitation, any component and/or components, part and/or parts common to and/or related to and/or used in association with a installation, maintenance and/or removal of a trap and/or hood in a corresponding catch basin of and/or a corresponding storm drain.

The trap installation device disclosed herein may additionally be offered, without limitation, in a kit comprising the device, a trap, and/or a corresponding catch basin.

The trap installation device disclosed herein may additionally be used in a method of installation of a trap in a corresponding catch basin of a storm drain.

Without departing from the scope and spirit of the present invention, reasonable features, dimensions, modifications, advantages, and design variations of the claimed load binding device will become readily apparent to those skilled in the art by following the guidelines set forth in the preceding detailed description and embodiments.

What is claimed is:

1. A device for installation, maintenance, or removal of a catch basin trap; the device comprising a shank connecting a handle on one end and jaw-like arms on an opposite end, wherein the handle end of the shank further comprises a lever capable of actuating the jaw-like arms for snap-action installation of a catch basin trap.

2. The device of claim 1, wherein the jaw-like arms are capable of swiveling at an angle sufficient for installing the trap in or removing the trap from a corresponding catch basin.

3. The device of claim 2, wherein the swivel of the jaw-like arms rotates the arms up to a 228° angle.

4. The device of claim 1, wherein the shank is hollow.

5. The device of claim 1, wherein the handle end comprises a hand grip.

6. The device of claim 1, wherein the lever is connected to a pin via a cable, and wherein the lever is capable of activating release of the pin for the snap-action installation.

7. A method for installing, maintaining, or removing a catch basin trap; the method comprising;
a.) providing a device comprising a shank connecting a handle on one end and jaw-like arms on an opposite end, wherein the handle end of the shank further comprises a lever capable of actuating the jaw-like arms for snap-action installation of a catch basin trap; and
b.) activating the lever of the device to actuate the jaw-like arms; thereby snapping into place a trap in a corresponding catch basin.

8. The method of claim 7, further comprising positioning the jaw-like arms at a desired angle for the snap-action installation of the trap into the corresponding catch basin.

9. A kit for installing a catch basin trap; the kit comprising:
a.) a device comprising a shank connecting a handle on one end and jaw-like arms on an opposite end, wherein the handle end of the shank further comprises a lever capable of actuating the jaw-like arms for snap-action installation of a catch basin trap; and
b.) a catch basin trap.
